(19) United States
(12) Patent Application Publication
(10) Pub. No.: US 2006/0253541 A1
(43) Pub. Date: Nov. 9, 2006

(54) Method and apparatus for performing an instant messenger function using a local area network

(75) Inventors: Min Jung Kim, Seoul (KR); Myung Eun Park, Seoul (KR); Jin Ho Son, Gyeonggi-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/429,005

(22) Filed: May 5, 2006

(30) Foreign Application Priority Data
May 9, 2005 (KR) 10-2005-0038551
Jun. 13, 2005 (KR) 10-2005-0050353

(51) Int. Cl. G06F 15/16

(52) U.S. Cl. 709/207

(57) ABSTRACT

An apparatus and method for performing an instant messenger function using a local area network (LAN) is provided whereby a first portable terminal and second portable terminals perform an instant messenger function via short-range communication. The first portable terminals and the second portable terminals respectively store user information and exchange the stored user information to establish themselves as messenger objects. The first portable terminal searches the second portable terminals of the messenger objects located within the short-range communication area obtains user information of the searched second portable terminals of messenger objects and updates the user information. The searched second portable terminals of the messenger objects are displayed as being active to allow a user to check the searched messenger objects and to perform an instant messenger function.

### CROSS-REFERENCE TO RELATED APPLICATIONS

Pursuant to 35 U.S.C. § 119(a), this application claims the benefit of earlier filing date and right of priority to Korean Application No. 10-2005-0038551, filed on May 9, 2005, and 10-2005-0050353, filed on Jun. 13, 2005, the contents of which are hereby incorporated by reference herein in their entirety.

### BACKGROUND OF THE INVENTION

1. Field of the Invention

This invention is directed to a method and apparatus for performing an instant messenger function using a local area network (LAN).

2. Description of the Related Art

Along with development of communication technologies, various short-range radio communication technologies for implementing a wireless communication at a short range have been developed. One of these short-range wireless communication technologies is Bluetooth (BT).

BT has evolved since version 1.0 was published as an official standard in July 1999. A maximum data transmission speed of Bluetooth is 1 Mbps, with an effective bi-directional transmission speed of 433.9 kbps in consideration of a packet header and a uni-directional transmission speed of 723.2 kbps with a transmission speed of 57.6 kbps in the other direction. Transmission distance is approximately 10 meters with 1 mW of transmission power and a maximum transmission power is 100 Mw.

BT operates in the unlicensed ISM (Industrial, Scientific, Medical) band at 2.4000˜2.4835 GHz and can support 79 channels on a 1 MHz bandwidth. Data is transmitted by changing approximately 1,600 channels per second in a Frequency Hopping Spread Spectrum method.

BT can transmit accurate data even in a noisy environment via communication using the Frequency Hopping Spread Spectrum method and can avoid frequency interference by hopping to a new frequency channel after transmission and reception of a predetermined packet. Therefore, BT communication hops faster than any other system operating in the same frequency bandwidth and can transmit data more stably using a shorter packet. In addition to BT, various other short-range wireless communication technologies are known, such as Zigbee, UWB (Ultra Wide Band) and LAN (Local Area Network).

The short-range communication, which is intended to replace wired communication with wireless communication, has a very wide field of use anticipated to continuously broaden. As short-range wireless communication technologies are integrated into various portable terminals, such as mobile communication terminals, the portable terminals enable communication via the short-range communication without using a base station that imposes a use charge. Furthermore, short-range communication can perform various instant messenger services, such as message exchanges, data transmissions and games.

In order to enable portable terminals to perform an instant messenger function, the portable terminals should be registered with user information of messenger objects. For example, user information such as user names, titles of conversations, avatars, telephone numbers, photographs and addresses for short-range communication modules should be registered.

Furthermore, if an instant messenger function is implemented by short-range communication, a search should be performed to determine whether the messenger objects are located within a short-range communication area of the portable terminals and a result of the search should be briefly indicated to the users of the portable terminals. The messenger objects may change any time the user information, such as avatars and photographs, changes and it is necessary to update the user information of the changed messenger objects.

Therefore, there is a need for a method and apparatus for efficiently performing an instant messenger function. The present invention addresses these and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

A first object of the present invention is to provide a method and apparatus for performing an instant messenger function using a local area network (LAN) whereby portable terminals located within a short-range communication area of a first portable terminal are searched, with the searched portable terminals established as a messenger object. A second object of the present invention is to provide a method and apparatus for performing an instant messenger function using a local area network, whereby portable terminals of a messenger object located within a short-range communication area are searched by a first portable terminal, with the result of the search indicated to a user. A third object of the present invention is to provide a method and apparatus for performing an instant messenger object search using a local area network, whereby user information is obtained from portable terminals searched by a first portable terminal in order to update stored messenger object information. A fourth object of the present invention is to provide a method and apparatus for performing an instant messenger function using a local area network, whereby portable terminals established as messenger objects can perform an instant messenger function.

In one aspect of the present invention, a method for performing an instant messenger function in a portable terminal is provided. The method includes storing user information in the portable terminal searching for at least one other portable terminal, exchanging the user information with the searched at least one other portable terminal, establishing the searched at least one other portable terminal as a messenger object and initiating a connection with the searched at least one other portable terminal to implement the instant messenger function.

It is contemplated that the user information includes a user name, a nickname, a telephone number, an avatar, a user photograph and/or a present mood of the user. It is further contemplated that the searching, exchanging, establishing and initiating steps are performed via short-range communication including Bluetooth, Zigbee, UWB (Ultra Wide Band) or LAN (Local Area Network).

It is contemplated that the method includes searching for the at least one other portable terminal when an additional messenger object command is received. It is further contemplated that searching for the at least one other portable terminal includes transmitting user information to the at least one other portable terminal, receiving user information from the at least one other portable terminal and displaying the received user information, wherein the at least one other portable terminal is located within a short-range communication area. It is further contemplated that establishing the messenger object includes transmitting the user information and a messenger object request signal to a portable terminal selected by a user from the searched at least one other portable terminal, receiving user information and a messenger object enable signal from the selected at least one other portable terminal in response to the messenger object request signal, storing the received user information in response to the messenger object request signal and setting up the selected at least one other portable terminal as the messenger object.

It is contemplated that implementing the instant messenger function includes searching for the at least one other portable terminal in response to a messenger object display command, obtaining information related to the searched at least one other portable terminal, comparing the obtained information to information related to the established messenger object in order to detect the at least one other portable terminal established as the messenger object, displaying at least one active messenger object and implementing the instant messenger function with the at least one other portable terminal of the at least one active messenger object. It is further contemplated that implementing the instant messenger function includes determining that an automatic mode is established, searching for the at least one other portable terminal according to a predetermined search time interval, obtaining information related to the at least one other portable terminal, comparing the obtained information to information related to the established messenger object in order to detect the at least one other portable terminal established as the messenger object, notifying a user that the at least one portable terminal of the messenger object have been detected and implementing the instant messenger function with the at least one other portable terminal of the messenger object.

It is contemplated that searching for the at least one other portable terminal includes searching within a predetermined search time band. It is further contemplated that notifying the user includes displaying the at least one other portable terminal as active and generating a vibration and/or a warning sound.

It is contemplated that the method includes searching for the at least one other portable terminal with which the instant messenger function was implemented, obtaining user information from the searched at least one other portable terminal and updating the user information of the searched at least one other portable terminal. It is further contemplated that updating the user information of the at least one other portable terminal includes searching for the at least one other portable terminal with which the instant messenger function was implemented in response to a search command to obtain information and comparing the obtained information to information related to the established messenger object in order to detect the at least one other portable terminal established as the messenger object. Preferably, searching for the at least one other portable terminal with which the instant messenger function was implemented includes determining that the search command was either a first command received after the portable terminal was turned or was received at least a predetermined time after a previous search command was received.

In another aspect of the present invention, a method for performing an instant messenger function in a portable terminal is provided. The method includes storing user information in the portable terminal, receiving a request for information from another portable terminal, exchanging the user information with the other portable terminal, establishing the other portable terminal as a messenger object and initiating a connection with the other portable terminal to implement the instant messenger function.

It is contemplated that the method includes a user of the portable terminal establishing a messenger receipt blocking condition or a messenger receipt allowance condition and remaining unresponsive to the received request for information if the messenger receipt blocking condition is established such that user information is not exchanged and the other portable terminal is not established as a messenger object. It is further contemplated that the method includes determining whether a user of the portable terminal has indicated that the other portable terminal should be established as messenger object and not establishing the other portable terminal as a messenger object if the user has not indicated that the other portable terminal should be established as a messenger object.

In another aspect of the present invention, a portable terminal for performing an instant messenger function is provided. The portable terminal includes a memory unit adapted to store user information, a short-range communication unit adapted to perform short-range communication, a command input unit adapted to allow a user to enter information, a display unit adapted to display information and a controller adapted to control the memory unit, short-range communication unit, command input unit and display unit to search for at least one other portable terminal, exchange the user information with the searched at least one other portable terminal, establish the searched at least one other portable terminal as a messenger object and initiate a connection with the searched at least one other portable terminal to implement the instant messenger function.

It is contemplated that the memory unit is further adapted to store user information including a user name, a nickname, a telephone number, an avatar, a user photograph and/or a present mood of the user. It is further contemplated that the short-range communication unit includes a Bluetooth module, a Zigbee module, a UWB (Ultra Wide Band) module or a LAN (Local Area Network) module.

It is contemplated that the controller is further adapted to search for the at least one other portable terminal when an additional messenger object command is received via the command input unit. It is further contemplated that the controller is further adapted to search for the at least one other portable terminal by transmitting user information to the at least one other portable terminal via the short-range communication unit, receiving user information from the at least one other portable terminal via the short-range communication unit and displaying the received user information on the display unit.

It is contemplated that the controller is further adapted to establish the messenger object by transmitting the user information and a messenger object request signal via the short-range communication unit to a portable terminal selected by the user from the searched at least one other portable terminal, receiving user information and a messenger object enable signal via the short-range communication unit from the selected at least one other portable terminal in response to the messenger object request signal, storing the received user information in the memory unit in response to the messenger object request signal and setting up the selected at least one other portable terminal as the messenger object. It is further contemplated that the controller is further adapted to implement the instant messenger function by searching for the at least one other portable terminal in response to a messenger object display command received via the command input unit, obtaining information related to the searched at least one other portable terminal, comparing the obtained information to information related to the established messenger object in order to detect the at least one other portable terminal established as the messenger object, displaying at least one active messenger object on the display unit and implementing the instant messenger function with the at least one other portable terminal of the at least one active messenger object.

It is contemplated that the controller is further adapted to implement the instant messenger function by determining that an automatic mode is established, searching for the at least one other portable terminal according to a predetermined search time interval, obtaining information related to the at least one other portable terminal, comparing the obtained information to information related to the established messenger object in order to detect the at least one other portable terminal established as the messenger object, notifying a user that the at least one portable terminal of the messenger object has been detected and implementing the instant messenger function with the at least one other portable terminal of the messenger object. It is further contemplated that the controller is further adapted to search for the at least one other portable terminal within a predetermined search time band.

It is contemplated that the controller is further adapted to notify the user by displaying the at least one other portable terminal as active on the display unit and generating a vibration and/or a warning sound. It is further contemplated that the controller is further adapted to receive a request for information from another portable terminal via the short-range communication unit, exchange the user information with the other portable terminal, establish the other portable terminal as a messenger object and initiate a connection with the other portable terminal to implement the instant messenger function.

It is contemplated that the controller is further adapted to determine that a user of the portable terminal has established one of a messenger receipt blocking condition and a messenger receipt allowance condition and remain unresponsive to the received request for information if the messenger receipt blocking condition is established such that user information is not exchanged and the other portable terminal is not established as a messenger object. It is further contemplated that the controller is further adapted to determine whether a user of the portable terminal has indicated that the other portable terminal should be established as messenger object and not establish the other portable terminal as a messenger object if the user has not indicated that the other portable terminal should be established as a messenger object.

It is contemplated that the controller is further adapted to search for the at least one other portable terminal with which the instant messenger function was implemented, obtain user information from the searched at least one other portable terminal and update the user information of the searched at least one other portable terminal stored in the memory unit. It is further contemplated that the controller is further adapted to update the user information of the at least one other portable terminal by searching for the at least one other portable terminal with which the instant messenger function was implemented in response to receiving a search command via the command input unit to obtain information and comparing the obtained information to information stored in the memory unit that is related to the established messenger object in order to detect the at least one other portable terminal established as the messenger object. Preferably, the controller is further adapted to search for the at least one other portable terminal with which the instant messenger function was implemented by determining that the search command was either a first command received after the portable terminal was turned or was received at least a predetermined time after a previous search command was received.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a block diagram of a mobile communication terminal incorporating a method for performing an instant messenger function according to the present invention.

FIGS. 2a to 2c illustrate flowcharts for establishing a messenger object in a method for performing an instant messenger function according to the present invention.

FIGS. 3a and 3b illustrate flowcharts for searching for a messenger object and updating information of the searched messenger object in a method for performing an instant messenger function according to the present invention.

FIGS. 4a and 4b illustrate flowcharts for searching for a messenger object in a method for performing an instant messenger function according to the present invention and for performing an instant messenger function with the searched messenger object.

### DETAILED DESCRIPTION OF THE PREFERRED EMBODIMENTS

The present invention relates to a method and apparatus for performing an instant messenger function. Although the present invention is illustrated with respect to a mobile communication device, it is contemplated that the present invention may be utilized anytime it is desired to perform an instant messenger function.

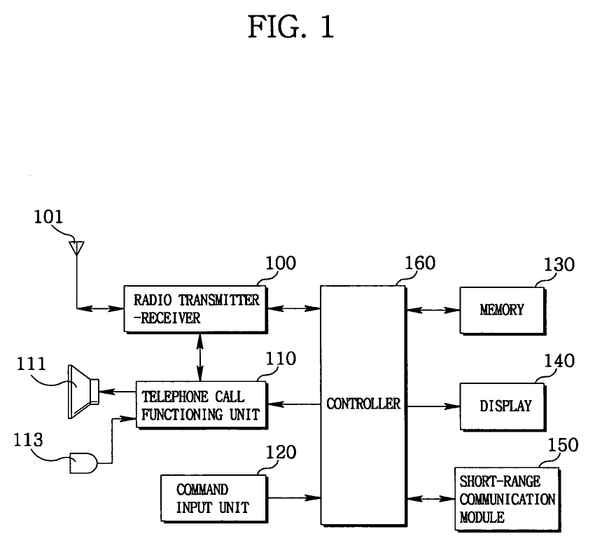

Referring to FIG. 1, a radio transmitter-receiver 100 communicates with a base station (not shown) via an antenna 101 such that a user can exchange voice signals with another user. A telephone call functioning unit 110 outputs the voice signal received by the radio transmitter-receiver 100 to a speaker 111 and transmits the voice signal of the user received through a microphone 113 via the radio transmitter-receiver to thereby allow a user to implement telephone communication.

A command input 120 unit includes a plurality of keys for inputting numerals and text information and function keys for establishing various operational functions of a portable terminal. The command input unit 120 further includes a plurality of function keys to enable the portable terminal to perform short-range communication and simultaneously perform an instant messenger function according to the present invention.

A memory 130 is loaded in advance with programs for controlling general operations of the portable terminal and programs for performing short-range communication between portable terminals according to the present invention. The memory 130 also stores predetermined data generated while the previously stored programs are performed. The memory 130 is further loaded with user information and information related to messenger objects established by a user for implementing the instant messenger function.

A display 140 facilitates display of various data generated while the portable terminal performs telephone communication or short-range communication. A short-range communication module 150 for performing short-range communication includes a bluetooth module, a Zigbee module, an Ultra Wide Band (UWB) module or a radio Local Area Network (LAN) module, thereby allowing the portable terminal to perform mutual short-range communication.

A controller 160 controls the radio transmitter-receiver 100 and the telephone call functioning unit 110 in response to an operation command from the command input unit 120 to enable a user to perform telephone communication. The controller 160 further controls the portable terminal in such a manner that the portable terminal mutually performs short-range communication via the short-range communication module 150 to establish a messenger object, updates the information of the messenger object and performs the instant messenger function.

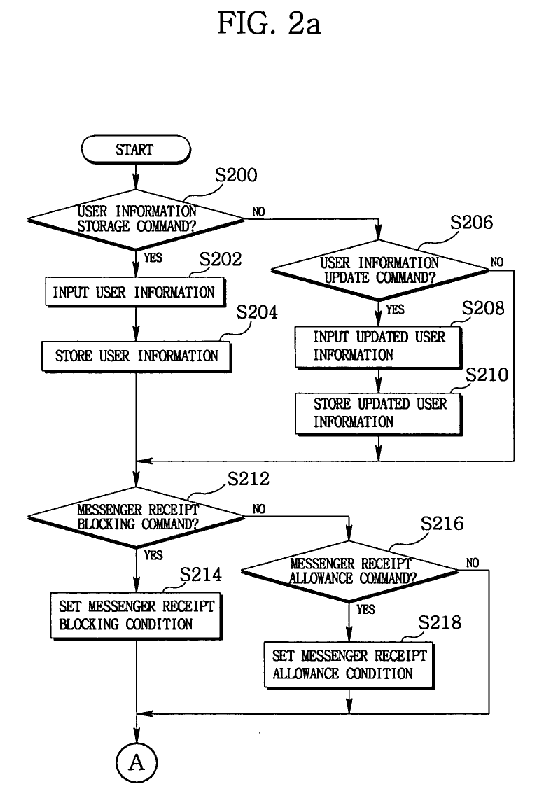

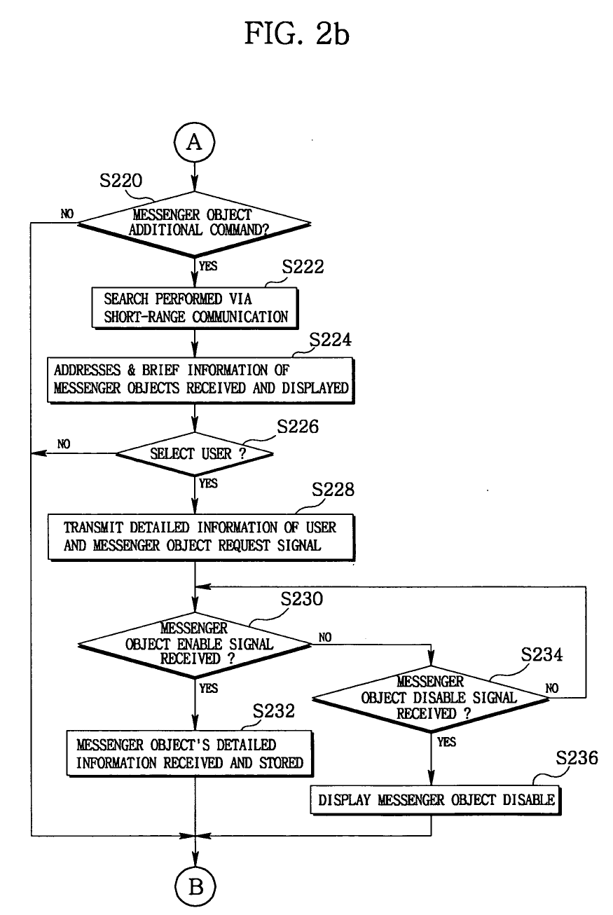

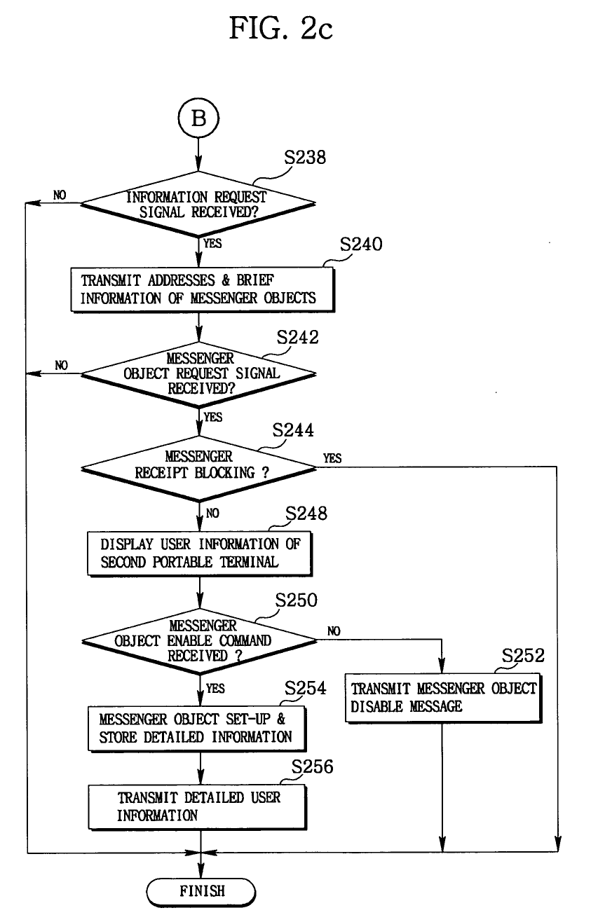

As illustrated in FIGS. 2a to 2c, user information is exchanged between a user and a messenger object when the messenger object is established such that the portable terminal first receives and stores the user information in the memory 130 before the messenger object is established. As illustrated in FIG. 2a, the controller 160 determines whether a command to store user information has been received from the command input unit 120 (S200). The controller 160 inputs the user information via the command input unit 120 if the storage command has been received (S202).

The user information may include, but is not limited to, a user name, a nickname for use when an instant messenger function is performed, a telephone number, an avatar, a user photograph or a present user mood. If the user information has been input, the controller 160 stores the user information in the memory 130 (S204).

If a command to store information has not been received, the controller 160 determines whether a command to update the user information has been received from the command input unit 120 (S206). The controller 160 displays the user information currently stored in the memory 130 on the display 140 if a user information update command has been received, thereby enabling the user to verify that the user information has been input.

The controller 160 inputs the updated user information via the command input unit 120 (S208) and stores the updated user information in the memory 130 after the updated information has been input (S210). The user information input by the user may be classified into brief information and detailed information. For example, brief information includes only the user names, nicknames and telephone numbers, while the detailed information includes all the information input by the user.

It should be noted that a user may or may not use an instant messenger function, according to his or her liking. Therefore, it is preferred that a user decides whether to use the instant messenger.

If the user uses the command input unit 120 to request that the messenger function be blocked (S212), the controller 160 establishes a messenger receipt blocking condition and does not implement the instant messenger function (S214). If the user uses the command input unit 120 to request that the messenger function be allowed (S216), the controller 160 establishes a messenger receipt allowance condition and performs the instant messenger function (S218). If the user and the messenger object mutually use the instant messenger function, they exchange information and the exchanged information is stored in the memory 130 such that the user and the messenger mutually establish themselves as messenger objects.

As illustrated in FIG. 2b, the controller 160 determines whether an additional command related to the messenger object for implementing the instant messenger function has been received from the command input unit 120 (S220). As used herein, a portable terminal of the user is a “first portable terminal” and other portable terminals used by messenger objects within the short-range communication area of the first portable terminal are “second portable terminals.” Furthermore, as used herein, “controller 160” refers to a controller of the first portable terminal unless otherwise stated.

The controller 160 controls the short-range communication module 150 to search for second portable terminals located within the short-range communication area if an additional messenger object command has been received by the first portable terminal (S222). For example, the controller 160 of the first portable terminal transmits brief information of the user and an information request signal via the short-range communication module 150 to search for second portable terminals located within the short-range communication area.

If the portable terminals are mounted with short-range communication modules, each short-range communication module is provided in advance with an intrinsic address and the provided address is stored in the memory 130. The first portable terminal transmits the address of the short-range communication module 150 when second portable terminal is searched.

If the second portable terminal responds to the search, the second portable terminal transmits the provided address of its short-range communication module and the brief information of the second portable terminal's user to the first portable terminal. The controller 160 receives the address transmitted by the second portable terminal and the brief information of the second portable terminal's user via the short-range communication module 150.

The brief information of the second portable terminal's user is received and displayed on the display 140 to allow the user of the first portable terminal to check the user of the second portable terminal (S224). The user of the first portable terminal checks the brief information of the second portable terminal's user that is displayed on the display 140 and uses the command input unit 120 to select the user of the second portable terminal desired as a messenger object (S226).

Successively, the controller 160 of the first portable terminal transmits the messenger object request signal and the detailed information of the user stored in the memory 130 to a relevant second portable terminal via the short-range communication module 150 (S228). In other words, the detailed information of the user and the messenger object request signal are transmitted to the relevant second portable terminal using the address of the messenger object selected by the user.

Furthermore, the controller 160 determines whether a messenger object enable signal has been received from the second portable terminal (S230). If the enable signal has been received, the controller 160 receives the detailed information of the messenger object transmitted by the second portable terminal and stores the signal and the information in the memory 130 in order to establish the second portable terminal as a messenger object (S232). If the messenger object enable signal is not received and a messenger object disable signal is received (S234), the controller 160 indicates the messenger object disable condition on the display 140 and terminates establishment of the messenger object (S236).

If the first portable terminal is located within the short-range communication area of the second portable terminal and the user of the second portable terminal inputs an additional messenger object command, the second portable terminal transmits an information request signal. The first portable terminal may respond to the second portable terminal in order to allow the user of the first portable terminal and the user of the second portable terminal to mutually establish themselves as messenger objects.

As illustrated in FIG. 2c, the controller 160 determines whether an address and information request signal transmitted by the second portable terminal have been received via the short-range communication module 150 (S238). If an information request signal has been received, the controller 160 transmits the address of the short-range communication module 150 and the brief information stored in the memory 130 to the second portable terminal via the short-range communication module 150 (S240).

The controller 160 then determines whether a signal requesting a messenger object has been received from the second portable terminal (S242). If a messenger object request signal has been received, the controller 160 determines whether messenger receipt blocking is currently established (S244).

If messenger receipt blocking has been established, the controller 160 does not respond to the messenger object request signal from the second portable terminal in order to prevent establishment of mutual messenger objects. If messenger receipt blocking is not established, the controller 160 displays the user information of the second portable terminal on the display 140 (S248).

In other words, if a messenger object request signal is received from the second portable terminal and messenger receipt blocking is not established, the detailed information of the second portable terminal's user is received and the controller 160 displays the detailed information of the second portable terminal's user on the display 140 such that the user of the first portable terminal can check the user of the second portable terminal. The controller 160 then determines whether a messenger object enable command has been received from the command input unit 120 (S250).

If a messenger object enable command has not been received, the controller 160 generates a messenger object disable message and transmits the message to the second portable terminal via the short-range communication module 150 such that mutual messenger objects are not established and terminates the operation (S252). If a messenger object enable command has been received, the controller 160 stores the detailed information of the second portable terminal's user that was received with the messenger object request signal in the memory 130 and establishes the second portable terminal as a messenger object (S254). Furthermore, the controller 160 transmits the detailed information of the user stored in the memory 130 to a relevant second portable terminal via the short-range communication module 150 in order to allow the second portable terminal to establish the first portable terminal as a messenger object (S256).

When implementing an instant messenger function, users of portable terminals may update user information, such as facial expression-changed avatars and photographs, according to their mood conditions. Therefore, it is necessary to update the information of the messenger object stored in the first portable terminal at the same time.

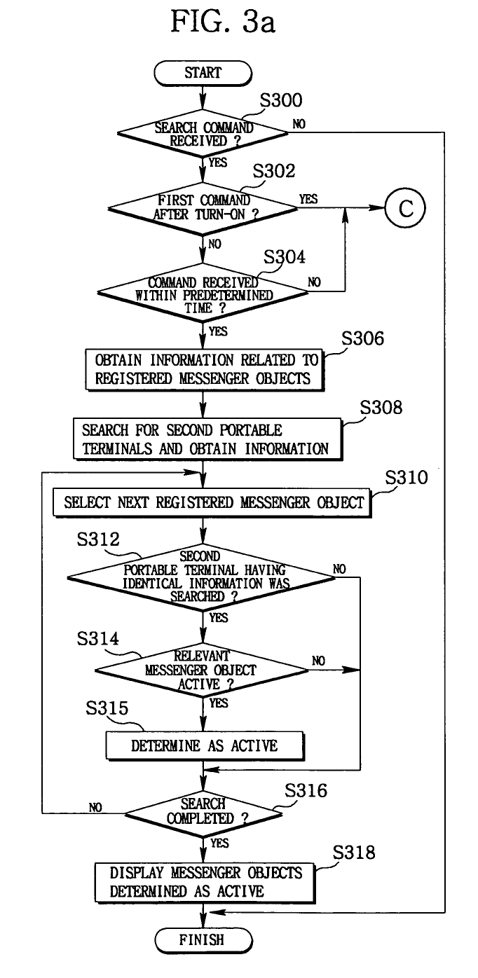

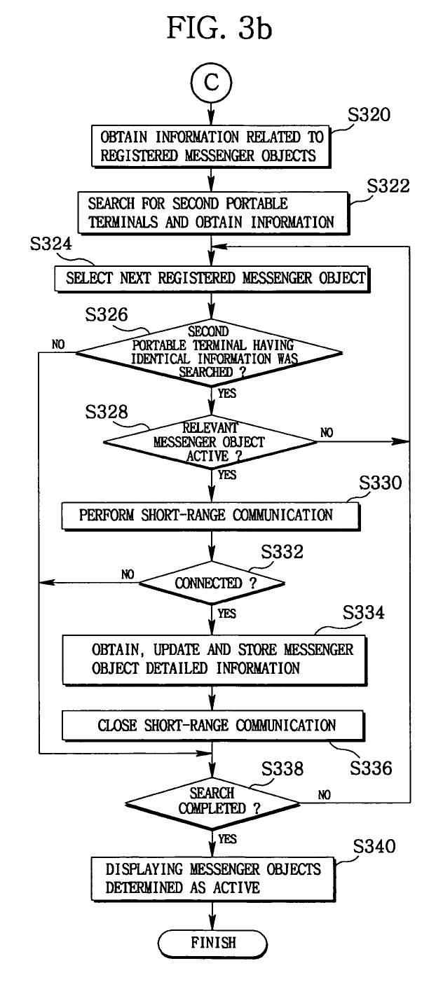

As illustrated in FIG. 3a, the controller 160 determines whether a search command for searching for a messenger object has been received from the command input unit 120 (S300). If a search command has been received, the controller 160 determines whether the search command is a first command following turn-on of the first portable terminal (S302) or is a search command received within a predetermined time after a previous search command was input (S304). For example, the controller 160 determines whether the search command is a first command after turn-on or is a search command re-input within 10 minutes of a previous search command.

If the search command is not the first command after turn-on but is received within the predetermined time after a previous search command, the controller 160 obtains information related to messenger objects registered in the memory 130 (S306). For example, the address of the short-range communication module 150 of second portable terminals of messenger objects is obtained from the memory 130.

The controller 160 successively controls the short-range communication module 150 to search for a plurality of second portable terminals located within the communication area of the short-range communication module and obtains information related to the searched second portable terminals (S308). For example, the address of the short-range communication module 150 of the second portable terminal is obtained.

Upon obtaining the address, the controller 160 selects the messenger objects registered in the memory 130 one-by-one (S310). The information of each selected messenger object and the information of the searched second portable terminals are compared to determine whether the searched second portable terminals have identical information (S312). For example, the controller 160 determines whether a searched second portable terminal has the same address as that of the short-range communication module 150 stored in the memory 130 as a messenger object.

If the second portable terminal having the same information has been searched, the controller 160 determines whether the relevant messenger object is in an active state for implementing short-range communication (S314). For example, the controller 160 determines if the relevant messenger object is located within the communication area of the short-range communication module 150 and, if the relevant messenger object is active, the controller 160 determines the messenger object as active (S315).

If a second portable terminal having the same information has not been searched, the controller 160 determines that the relevant messenger object is not located within the communication area of the short-range communication module 150 and cannot perform the short-range communication. Furthermore, if the relevant messenger object is not active, the controller 160 determines that the messenger object cannot perform the short-range communication.

Next, the controller 160 determines whether searches for all the messenger objects registered in the memory 130 have been completed (S316). If the searches for all the messenger objects have not been completed, the controller 160 selects a next registered messenger object and repeats the process to determine whether the next registered messenger object has information identical to the searched portable terminals and is active.

Upon completing the searches for all messenger objects registered with the memory 130, the controller 160 lists the messenger objects determined as active on the display 140 (S318) and ends the search operation of the messenger objects.

The operation steps (S306-S318) are performed only if a search command for searching for a messenger object is received again within the predetermined time. Therefore, the information of the messenger objects is updated infrequently such that the messenger object is searched and the user is notified only whether the messenger object is in the active state.

As illustrated in FIG. 3b, the controller 160 obtains information of messenger objects registered in the memory 130 if the received search command is the first command following turn-on of the portable terminal or is received after the predetermined time following a previous search command (S320). The controller 160 then searches a plurality of second portable terminals located within the communication area of the short-range communication module 150 and receives information related to the searched plurality of second portable terminals (S322).

Upon updating the information of the plurality of second portable terminals, the controller 160 selects the messenger objects registered with the memory 130 one-by-one (S324). The information of the selected messenger objects and the information of the searched plurality of second portable terminals are compared to determine whether a second portable terminal having identical information has been searched (S326).

If a second portable terminal having the same information has been searched, the controller 160 determines whether the relevant messenger object is in an active state for implementing the short-range communication (S328). If the relevant messenger object is active, the controller 160 performs a short-range communication with the second portable terminal having the same information as that of the messenger object (S330) and determines whether the first portable terminal has been connected to the second portable terminal via short-range communication (S332). If the relevant messenger object is not active, the controller 160 determines that the messenger object cannot perform the short-range communication.

If the second portable terminal having the same information as that of the messenger object is connected to the first portable terminal via short-range communication, the controller 160 requests and obtains the detailed information of the messenger object from the second portable terminal and the obtained detailed information of the messenger object is updated and stored in the memory 130 (S334). For example, detailed information such as name of the messenger object, title of the conversation, avatar, telephone number or photograph is obtained, updated and stored in the memory 130.

Upon updating the detailed information of the messenger object, the controller 160 closes the short-range communication with the relevant second portable terminal (S336). The controller 160 then determines whether searches for all the registered messenger objects have been completed (S338).

If the searches have not been completed, the controller 160 selects another unsearched messenger object registered with the memory 130, compares the information and determines whether the messenger object has information identical to the searched portable terminals and is active. If another messenger object having identical information to the searched portable terminal is active, the first portable terminal and the second portable terminal of relevant messenger object are connected via short-range communication and the process to update and store the user information of the second portable terminal is repeated. Upon completing the searches for all registered messenger objects, the controller 160 displays the messenger objects that have been determined as active (S340) and ends the search operation of the messenger objects.

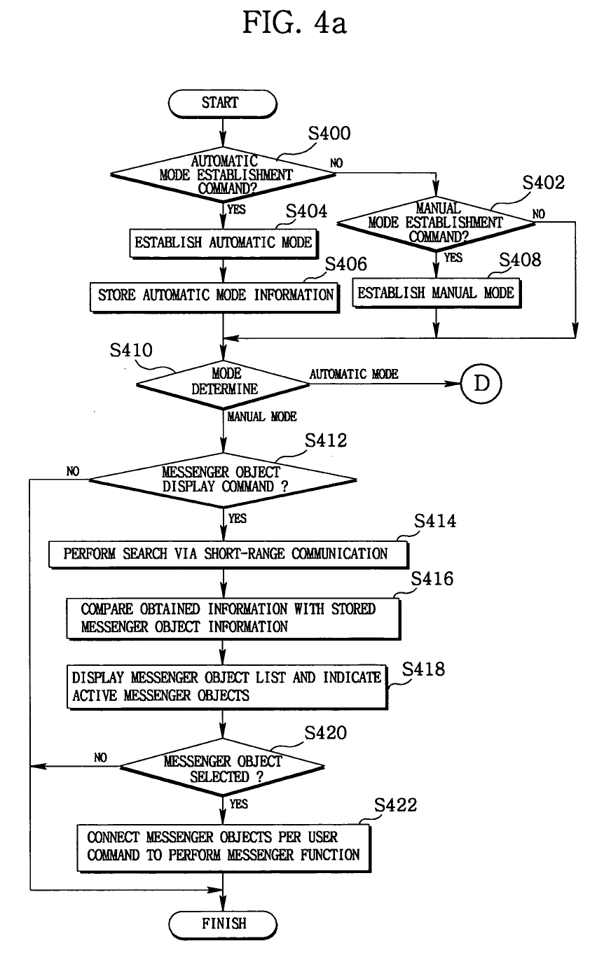

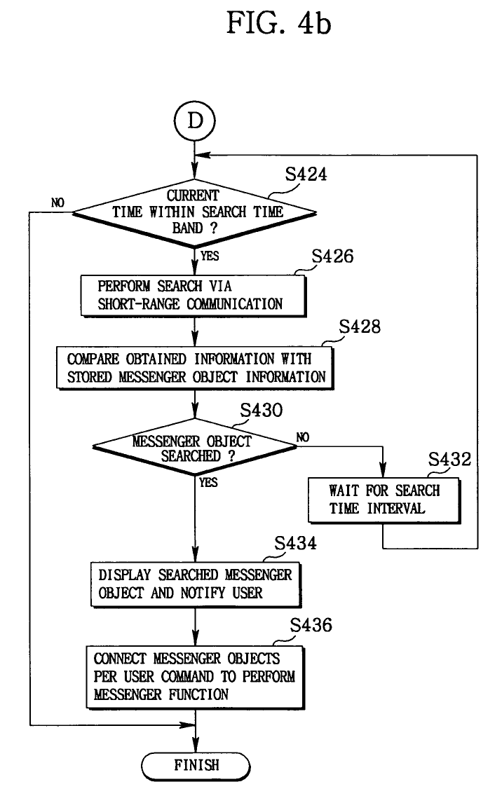

As illustrated in FIG. 4a, the controller 160 determines whether an automatic mode establishment command has been received from the command input unit 120 (S400). The controller 160 also determines whether a manual mode establishment command has been received (S402).

If the automatic mode establishment command has been received, the controller 160 establishes an automatic mode (S404) and stores automatic mode establishment information received from the command input unit 120 (S406). For example, a search time band is established from 9 am to 12 pm in which a messenger object is to be searched in the automatic mode and a search time interval is established at every 10 minutes in which the messenger object is to be searched in the search time band.

If no automatic mode establishment command is received, but a manual mode establishment command is received from the command input unit 120, the controller 160 establishes the manual mode (S408). The controller 160 then determines whether an instant messenger function automatic mode or manual mode was established (S410).

In the manual mode, a messenger object is searched and displayed in response to user command and the instant messenger function is performed. If the manual mode is established, the controller 160 determines whether a messenger object display command has been received from the command input unit 120 (S412). If the messenger object display command was received, the controller 160 searches for a plurality of second portable terminals located in the vicinity of the first portable terminal via short-range communication in order to obtain information related to the second portable terminals (S414). For example, addresses of short-range modules mounted in the second portable terminals are obtained.

If brief information of the users of the second portable terminals is obtained, the controller 160 compares the obtained addresses with those of the messenger objects stored in the memory 130 to determine whether messenger objects have been searched (S416). The controller 160 then displays a messenger object list on the display 140 showing information related to the searched plurality of second portable terminals and indicates as active the messenger objects having the same address as the obtained addresses (S418).

The controller 160 then determines whether the user has selected one of the messenger objects indicated on the display 140 as active via the command input unit 120 (S420). If a messenger object has been selected by the user, the controller 160 controls the short-range communication module 150 to connect the second portable terminal of the messenger object via short-range communication and to perform the instant messenger function (S422). In other words, the second portable terminal corresponding to the messenger object selected by the user is connected via short-range communication and various instant messenger functions are performed, such as chatting, transmission of text messages and game activities.

In the automatic mode, messenger objects are searched and displayed at a predetermined interval and the instant messenger function is performed. As illustrated in FIG. 4b, if the automatic mode is established, the controller 160 determines whether the current time is within a search time band established as part of the automatic mode (S424). If the current time is within the search time band, the controller 160 searches for a plurality of second portable terminals located adjacent to the first portable terminal via the short-range communication to obtain addresses of the second portable terminals (S426).

If brief information of the addresses of the second portable terminals is obtained, the controller 160 compares the obtained addresses with those of the messenger objects stored in the memory 130 (S428) to determine whether messenger objects have been searched (S430). If messenger objects have not been searched, the controller 160 waits for a predetermined search time interval (S432) and then again performs the short-range communication if the current time is still within the search time band in order to search for second portable terminals adjacent to the first portable terminal and determine whether messenger objects have been searched.

If messenger objects have been searched, the controller 160 lists the searched messenger objects on the display 140 and notifies the user via a warning sound or a vibration (S434). The controller 160 then controls the short-range communication module 150 in response to a user command to connect the first portable terminal to the second portable terminal of the messenger object and perform the instant messenger function (S436).

According to the present invention, a first portable terminal searches second portable terminals capable of performing an instant messenger function according to a search command. In this way, a user of the first portable terminal can simply check the messenger objects capable of implementing the instant messenger function at a current position. User information updated by the second portable terminals can be easily obtained, updated and stored by the first portable terminal. Furthermore, a user of a portable terminal can easily check if there is a messenger object nearby and can perform chatting, transmission of text messages and game activities when portable terminals having a short-range communication function implement short-range communication to perform the instant messenger function.

The present invention is not limited to the described embodiments. Instead, it will be appreciated by those skilled in the art that various changes may be made to the embodiments without departing from the principles and spirit of the invention, the scope of which is defined by the claims and their equivalents. As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for performing an instant messenger function in a portable terminal, the method comprising:
storing user information in the portable terminal;
searching for at least one other portable terminal;
exchanging the user information with the searched at least one other portable terminal;
establishing the searched at least one other portable terminal as a messenger object; and
initiating a connection with the searched at least one other portable terminal to implement the instant messenger function.

2. The method of claim 1, wherein the user information comprises at least one of a user name, a nickname, a telephone number, an avatar, a user photograph and a present mood of the user.

3. The method of claim 1, wherein the searching, exchanging, establishing and initiating steps are performed via short-range communication comprising one of Bluetooth, Zigbee, UWB (Ultra Wide Band) and LAN (Local Area Network).

4. The method of claim 1, further comprising searching for the at least one other portable terminal when an additional messenger object command is received.

5. The method of claim 1, wherein searching for the at least one other portable terminal comprises:
transmitting user information to the at least one other portable terminal;
receiving user information from the at least one other portable terminal; and
displaying the received user information,
wherein the at least one other portable terminal is located within a short-range communication area.

6. The method of claim 1, wherein establishing the messenger object comprises:
transmitting the user information and a messenger object request signal to a portable terminal selected by a user from the searched at least one other portable terminal;
receiving user information and a messenger object enable signal from the selected at least one other portable terminal in response to the messenger object request signal;
storing the received user information in response to the messenger object request signal; and
setting up the selected at least one other portable terminal as the messenger object.

7. The method of claim 1, wherein implementing the instant messenger function comprises:
searching for the at least one other portable terminal in response to a messenger object display command;
obtaining information related to the searched at least one other portable terminal;
comparing the obtained information to information related to the established messenger object in order to detect the at least one other portable terminal established as the messenger object;
displaying at least one active messenger object; and
implementing the instant messenger function with the at least one other portable terminal of the at least one active messenger object.

8. The method of claim 1, wherein implementing the instant messenger function comprises:
determining that an automatic mode is established;
searching for the at least one other portable terminal according to a predetermined search time interval;
obtaining information related to the at least one other portable terminal;
comparing the obtained information to information related to the established messenger object in order to detect the at least one other portable terminal established as the messenger object;
notifying a user that the at least one portable terminal of the messenger object have been detected; and
implementing the instant messenger function with the at least one other portable terminal of the messenger object.

9. The method of claim 8, wherein searching for the at least one other portable terminal comprises searching within a predetermined search time band.

10. The method of claim 8, wherein notifying the user comprises displaying the at least one other portable terminal as active and generating at least one of a vibration and a warning sound.

11. The method of claim 1, further comprising:
searching for the at least one other portable terminal with which the instant messenger function was implemented;
obtaining user information from the searched at least one other portable terminal; and
updating the user information of the searched at least one other portable terminal.

12. The method of claim 11, wherein updating the user information of the at least one other portable terminal comprises:
searching for the at least one other portable terminal with which the instant messenger function was implemented in response to a search command to obtain information; and
comparing the obtained information to information related to the established messenger object in order to detect the at least one other portable terminal established as the messenger object.

13. The method of claim 12, wherein searching for the at least one other portable terminal with which the instant messenger function was implemented comprises determining that the search command was either a first command received after the portable terminal was turned or was received at least a predetermined time after a previous search command was received.

14. A method for performing an instant messenger function in a portable terminal, the method comprising:
storing user information in the portable terminal;
receiving a request for information from another portable terminal;
exchanging the user information with the other portable terminal;
establishing the other portable terminal as a messenger object; and
initiating a connection with the other portable terminal to implement the instant messenger function.

15. The method of claim 14, further comprising:
a user of the portable terminal establishing one of a messenger receipt blocking condition and a messenger receipt allowance condition; and
remaining unresponsive to the received request for information if the messenger receipt blocking condition is established such that user information is not exchanged and the other portable terminal is not established as a messenger object.

16. The method of claim 14, further comprising:
determining whether a user of the portable terminal has indicated that the other portable terminal should be established as messenger object; and
not establishing the other portable terminal as a messenger object if the user has not indicated that the other portable terminal should be established as a messenger object.

17. A portable terminal for performing an instant messenger function, the portable terminal comprising:
a memory unit adapted to store user information;
a short-range communication unit adapted to perform short-range communication;
a command input unit adapted to allow a user to enter information;
a display unit adapted to display information; and
a controller adapted to control the memory unit, short-range communication unit, command input unit and display unit to search for at least one other portable terminal, exchange the user information with the searched at least one other portable terminal, establish the searched at least one other portable terminal as a messenger object and initiate a connection with the searched at least one other portable terminal to implement the instant messenger function.

18. The portable terminal of claim 17, wherein the memory unit is further adapted to store user information comprising at least one of a user name, a nickname, a telephone number, an avatar, a user photograph and a present mood of the user.

19. The portable terminal of claim 17, wherein the short-range communication unit comprises one of a Bluetooth module, a Zigbee module, a UWB (Ultra Wide Band) module and a LAN (Local Area Network) module.

20. The portable terminal of claim 17, wherein the controller is further adapted to search for the at least one other portable terminal when an additional messenger object command is received via the command input unit.

21. The portable terminal of claim 17, wherein the controller is further adapted to search for the at least one other portable terminal by:
transmitting user information to the at least one other portable terminal via the short-range communication unit;
receiving user information from the at least one other portable terminal via the short-range communication unit; and
displaying the received user information on the display unit.

22. The portable terminal of claim 17, wherein the controller is further adapted to establish the messenger object by:
transmitting the user information and a messenger object request signal via the short-range communication unit to a portable terminal selected by the user from the searched at least one other portable terminal;
receiving user information and a messenger object enable signal via the short-range communication unit from the selected at least one other portable terminal in response to the messenger object request signal;
storing the received user information in the memory unit in response to the messenger object request signal; and
setting up the selected at least one other portable terminal as the messenger object.

23. The portable terminal of claim 17, wherein the controller is further adapted to implement the instant messenger function by:
searching for the at least one other portable terminal in response to a messenger object display command received via the command input unit;
obtaining information related to the searched at least one other portable terminal;
comparing the obtained information to information related to the established messenger object in order to detect the at least one other portable terminal established as the messenger object;
displaying at least one active messenger object on the display unit; and
implementing the instant messenger function with the at least one other portable terminal of the at least one active messenger object.

24. The portable terminal of claim 17, wherein the controller is further adapted to implement the instant messenger function by:
determining that an automatic mode is established;
searching for the at least one other portable terminal according to a predetermined search time interval;
obtaining information related to the at least one other portable terminal;
comparing the obtained information to information related to the established messenger object in order to detect the at least one other portable terminal established as the messenger object;
notifying a user that the at least one portable terminal of the messenger object has been detected; and
implementing the instant messenger function with the at least one other portable terminal of the messenger object.

25. The portable terminal of claim 24, wherein the controller is further adapted to search for the at least one other portable terminal within a predetermined search time band.

26. The portable terminal of claim 24, wherein the controller is further adapted to notify the user by:
displaying the at least one other portable terminal as active on the display unit; and
generating at least one of a vibration and a warning sound.

27. The portable terminal of claim 17, wherein the controller is further adapted to:
receive a request for information from another portable terminal via the short-range communication unit;
exchange the user information with the other portable terminal;
establish the other portable terminal as a messenger object; and
initiate a connection with the other portable terminal to implement the instant messenger function.

28. The portable terminal of claim 27, wherein the controller is further adapted to:
determine that a user of the portable terminal has established one of a messenger receipt blocking condition and a messenger receipt allowance condition; and
remain unresponsive to the received request for information if the messenger receipt blocking condition is established such that user information is not exchanged and the other portable terminal is not established as a messenger object.

29. The portable terminal of claim 27, wherein the controller is further adapted to:
determine whether a user of the portable terminal has indicated that the other portable terminal should be established as messenger object; and
not establish the other portable terminal as a messenger object if the user has not indicated that the other portable terminal should be established as a messenger object.

30. The portable terminal of claim 17, wherein the controller is further adapted to:
search for the at least one other portable terminal with which the instant messenger function was implemented;
obtain user information from the searched at least one other portable terminal; and
update the user information of the searched at least one other portable terminal stored in the memory unit.

31. The portable terminal of claim 30, wherein the controller is further adapted to update the user information of the at least one other portable terminal by:
searching for the at least one other portable terminal with which the instant messenger function was implemented in response to receiving a search command via the command input unit to obtain information; and
comparing the obtained information to information stored in the memory unit that is related to the established messenger object in order to detect the at least one other portable terminal established as the messenger object.

32. The portable terminal of claim 31, wherein the controller is further adapted to search for the at least one other portable terminal with which the instant messenger function was implemented by determining that the search command was either a first command received after the portable terminal was turned or was received at least a predetermined time after a previous search command was received.
